(19) United States
(12) Patent Application Publication
(10) Pub. No.: US 2007/0112917 A1
(43) Pub. Date: May 17, 2007

(54) A Keyboard for Quickly Activating Instant Messaging on the Internet

(75) Inventor: Harrison Tang, Taipei (TW)

Correspondence Address: PAI PATENT & TRADEMARK LAW FIRM, 1001 FOURTH AVENUE, SUITE 3200, SEATTLE, WA, 98154, US

(73) Assignee: H.L.L. INVESTMENT LTD., Taipei (TW)

(21) Appl. No.: 11/164,157

(22) Filed: Nov. 11, 2005

(51) Int. Cl. G06F 15/16

(52) U.S. Cl. 709/206

(57) ABSTRACT

A keyboard for quickly activating instant messaging (IM) on the Internet, the keyboard having a hot key installed thereon or any one of existing keys on said keyboard acting as a preset key, said hot key or said preset key working with an instant messenger executed on a computer and coupling with a speech I/O device to quickly activate transmission or reception of instant messages on the Internet with one single key, thereby implementing IM capabilities of the present invention.

### BACKGROUND OF THE INVENTION

1. Field of the Invention

The present invention relates to a keyboard for quickly activating instant messaging (IM) on the Internet and more particularly to a keyboard using a hot key or a preset key to facilitate the use of instant messaging on the Internet.

2. Description of the Prior Art

As the Internet becomes more popular, surfing the Internet has now become part of everyday life for most people. In addition to tapping its huge resources for data searching needs, a large number of Internet surfers are obsessed with the far reaching networking environment for making friends online using popular instant messengers such as Skype, MSN, ICQ, QQ, Yahoo and Net2phone, etc.

Fueled by the progress of hardware structure and the ever-expanding network bandwidth, now it is more viable to transfer multimedia contents such as music files and pictures on the Internet, and to provide IM capabilities as well, which further stimulate the adoption of network phone and video conference.

It is now very convenient to establish an IM connection with others, however, due to the complexity of configuring an IM session on the Internet compared to the readiness of traditional telephone devices, it is not likely that IM will replace telephones anytime soon. Therefore, building a convenient hardware and software environment is the first priority in providing a perfect IM service to users.

Generally, an instant messenger uses PC monitor to display a virtual phone device for user to use a mouse to click on a specific position to activate a certain capability. However, it's not efficient to operate on the screen, besides that users tend to have more than one application executed on the computer at the same time, which makes the operation more complicated and even degrades the responsiveness of the mouse, leading to operation delay of the IM function.

In view of the above-described deficiency, the inventor of this invention has consequently developed and proposed a keyboard to enable fast and easy operation for users to communicate with no limitation, to encourage the use of IM on the Internet and to enhance the availability of the Internet.

### SUMMARY OF THE INVENTION

It is an object of the present invention to provide a keyboard for quickly activating instant messaging (IM) on the Internet, wherein the keyboard is able to simplify the process of IM capabilities and to improve the quality of IM.

It is another object of the present invention to provide a keyboard for quickly activating IM on the Internet, wherein the keyboard provides a hot key or preset key, which is configurable for operations in different situations.

It is still another object of the present invention to provide a keyboard for quickly activating IM on the Internet, wherein the keyboard works with instant messengers such as Skype, MSN, ICQ, QQ, Yahoo, and Net2phone to provide easy-to-operate capabilities to users.

A keyboard for quickly activating IM on the Internet comprises a keyboard having a hot key or a preset key installed thereon, the hot key or preset key working with an instant messenger executed on a computer and coupling with a speech I/O device to quickly activate transmission or reception of instant messages on the Internet with one single key, thereby implementing IM capabilities of the present invention.

### BRIEF DESCRIPTION OF THE DRAWINGS

The drawings disclose a preferred embodiment of the present invention which serves to exemplify the various advantages and objects hereof, and are as follows:

FIG. 1 illustrates a structural configuration of the present invention.

### DETAILED DESCRIPTION OF THE PREFERRED EMBODIMENT

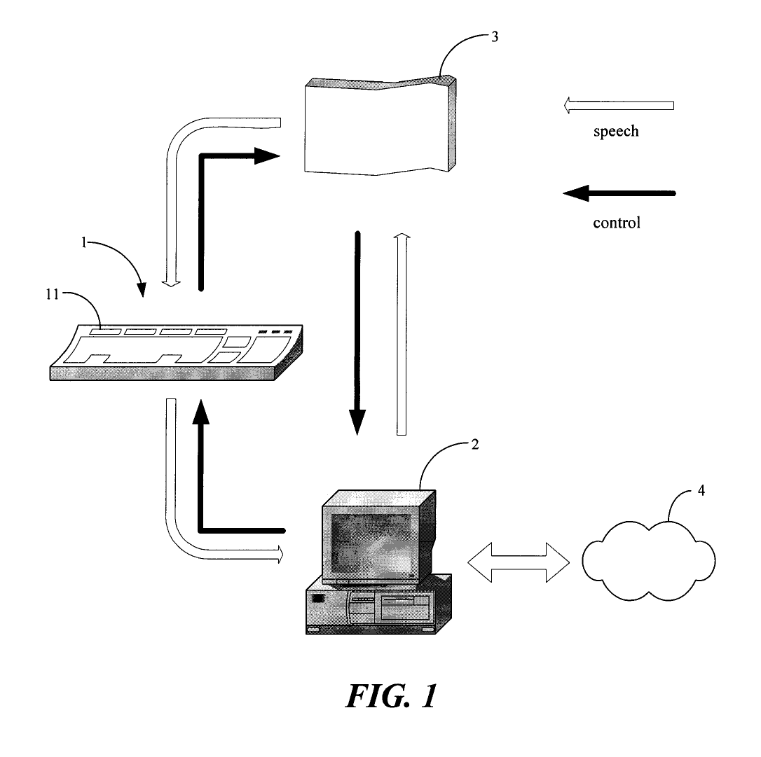

Please refer to FIG. 1, which illustrates a keyboard 1 for quickly activating instant messaging (IM) on the Internet in the present invention. Keyboard 1 has a hot key 11 installed thereon. The hot key 11 works with instant messengers such as Skype, MSN, ICQ, QQ, Yahoo and Net2phone, etc. The hot key 11 also couples with a speech I/O device such as a speaker, a microphone, or a handset of a telephone, etc., to activate transmission or reception of instant messages on the Internet with one single key to implement IM capabilities. Users can choose any one of existing keys on the keyboard 1 as a preset key to realize IM capabilities as described above. Of course, user can choose to use either the hot key 11 or one preset key, or use them simultaneously, or choose more hot keys or preset keys, then use software to configure a function for each key so chosen to facilitate the use of IM capabilities.

The beginning and the end of the control process and the data flow of IM in the present invention are described below:

1) A remote user calls a computer 2 of a local user via the Internet 4;

2) An instant messenger 3 on the computer 2 notifies the local user to answer the call;

3) The local user presses the hot key 11 or a preset key on the keyboard 1 to agree or disagree to communicate; and

4) The local user uses the instant messenger 3 to communicate.

Similarly, the local user can press the hot key 11 or a preset key to call the remote user, who can decide whether to take the call or not.

Users can use software to configure the hot key 11 or preset key. For example, when the instant messenger 3 calls, pressing the hot key 11 or the preset key will accept or decline the call; or when the user agrees to take the call, pressing the hot key 11 or the preset key will initiate a verbal conversation; or in the middle of the conversation, the hot key 11 or the preset key may be used to control the volume; or in the middle of the conversation, the hot key 11 or the preset key may be used to interrupt or to end the conversation. Furthermore, the user can configure the hot key 11 or the preset key to have different functions when the key is pressed once, twice, or even more times.

Many changes and modifications in the above described embodiment of the invention can, of course, be carried out without departing from the scope thereof. Accordingly, the invention is intended to be limited only by the scope of the appended claims.

What is claimed is:

1. A keyboard for quickly activating instant messaging on the Internet, comprises a keyboard having a hot key or a preset key installed thereon to quickly activate transmission or reception of an instant message on the Internet with one single key.

2. The keyboard of claim 1, wherein said hot key or preset key works with an instant messaging software.

3. The keyboard of claim 2, wherein said instant messaging software is selected from the group consisting of Skype, MSN, ICQ, QQ, Yahoo, and Net2phone.

4. The keyboard of claim 1, wherein said hot key or preset key couples with a speech I/O device.

5. The keyboard of claim 4, wherein said speech I/O device is a speaker, a microphone, or a telephone handset.

6. The keyboard of claim 1, wherein said hot key or preset key is configurable by software at any time.

7. The keyboard of claim 1, wherein said keyboard comprises one or more hot keys or preset keys for configuring different control functions.
